(19) United States
(12) Patent Application Publication
(10) Pub. No.: US 2013/0151212 A1
(43) Pub. Date: Jun. 13, 2013

(54) SYSTEMS, METHODS AND DEVICES FOR DETERMINING ENERGY CONSERVATION MEASURE SAVINGS

(71) Applicants: Anthony R. Gray, Victoria (CA); John C. Van Gorp, Sidney (CA)

(72) Inventors: Anthony R. Gray, Victoria (CA); John C. Van Gorp, Sidney (CA)

(73) Assignee: Schneider Electric USA, Inc., Palatine, IL (US)

(21) Appl. No.: 13/323,944

(22) Filed: Dec. 13, 2011

(51) Int. Cl. G06F 17/10

(52) U.S. Cl. 703/2

(57) ABSTRACT

Systems, methods, and devices for monitoring and modeling energy consumption are presented herein. A computer-implemented method of monitoring and modeling an energy load in an electrical system is featured. This method includes: determining one or more monitoring parameters; determining an energy conservation measure (ECM) evaluation period; creating an evaluation model of energy load over the ECM evaluation period based on the monitoring parameter(s), the evaluation model including one or more driver variables and at least one additional driver variable that is representative of at least one energy conservation measure; determining a coefficient of the at least one additional driver variable within an equation representing the ECM evaluation model; and outputting to a user the coefficient of the at least one additional driver variable. The coefficient represents the average change in energy due to the energy conservation measure(s) associated with the additional driver variable(s).

### TECHNICAL FIELD

The present disclosure relates generally to the monitoring of physical systems. More particularly, the present disclosure relates to systems, methods and devices for monitoring and modeling energy consumption of a physical system.

### BACKGROUND

Physical systems, such as electrical utility systems and heating, ventilation, and air conditioning (HVAC) systems, may be monitored by a network of intelligent electronic devices (“IEDs”) communicatively coupled to a computer and/or server for monitoring various parameters and/or characteristics of the physical system. In addition to monitoring these systems, the physical systems may be mathematically modeled in a number of ways. Generally, the models take one or more qualities of the physical system that can be measured or observed, and predict a numerical characterization of some other quality of the system that is thought to be causally influenced by the observed qualities. The observable qualities of the physical system that can be measured or observed are often referred to as “driver variables” or “independent variables.” The quality of the system that is thought to be causally influenced by the driver variable(s) is called the “modeled variable” or “dependent variable.”

One approach to modeling a physical system is by the use of a linear model, which computes a predicted quantity as a linear combination of scaled input quantities. However, some physical systems may have regimes of linear or piecewise linear behaviour, each of which can be modeled well separately, but for which no single model will work for all of the regimes of applicability. The physical system may be modeled well using a linear model or a piecewise linear model with driver variables for each mode separately, but no single model can be constructed that works well for all modes.

Energy consumption in buildings and industrial processes can be a significant cost to businesses. In the interest of saving money by reducing consumption, many strategies for reducing energy consumption can be pursued. The effectiveness of remedial efforts to reduce consumption can be difficult to determine, since they are sometimes confounded by uncontrollable and unforeseen changes in external conditions that drive energy consumption in the first place. A company, for example, may install high-efficiency lighting right before an unanticipated heat-wave causes cooling-related energy consumption to increase substantially. An uninformed observer of the overall increase in energy consumption might conclude that the switch to high-efficiency lighting was ineffective or, worse, counterproductive. Thus, a continuing need exists for improved systems and methods of modeling physical systems which make it possible to distinguish between energy consumption explained by changes in driver variables from that which isn't.

### SUMMARY

Aspects of the present disclosure are directed to systems, method and devices for modifying and recalculating the energy monitoring and linear change-point model of a facility (e.g., that predicts the energy consumption based on weather, occupancy, and/or other drivers) to determine the exact amount of energy savings attributable to a change (e.g., a building lighting retrofit) made on a particular date. The advantage of testing for energy savings in this manner, rather than simply comparing the average energy consumption before and after the change implementation date, is that the system can be automatically adjusted for one or more or all of the driver variables that may influence consumption. For instance, if a facility has energy monitoring and a working linear change-point model that predicts the facility's energy consumption, that model can be modified and recalculated to determine the exact amount of energy savings attributable to a change made on a particular date. This approach can produce both an estimate of energy savings and an indicator of the uncertainty associated that estimate, which in turn can be used to establish a confidence interval around the estimate.

Aspects of the present disclosure are also directed to systems, methods, and computer program products that provide flexible and accurate predictions of physical system behaviors for systems with distinct operating modes. In this vein, systems and methods of the present disclosure can model physical systems with distinct operating modes. An example of these types of systems includes complex systems under computer control, such as energy load monitoring and management systems, complex industrial systems, heating, ventilation, and air conditioning (HVAC) systems, production line systems, and other systems where energy is consumed.

An unequivocal indication of energy savings resulting from a specific energy conservation method which is unaffected by changes in other drivers of energy consumption would make it possible to compare true savings against pre-change estimates. This can be particularly helpful, for example, when such estimates are prepared by parties with an incentive to overestimate the benefits, such as energy retrofit contractors.

Energy consumption may be a cost driver in many types of physical systems, including office buildings, commercial and industrial facilities, and the like. The more efficiently the operator is able to monitor and manage energy consumption and energy costs, the lower the overall cost of running the facility. Aspects of this disclosure include systems, methods, and computer program products that can accurately and efficiently monitor and manage energy consumption using computer-generated models. The energy load may include measurements of a utility service quantity, such as an electrical utility service, a gas utility service, a water utility service, an air utility service, a steam utility service, and the like.

A computer-readable storage media for modeling and monitoring an energy load can include one or more computer-readable instructions configured to cause one or more computer processors to execute operations including defining a dependent variable, which represents an operation of the energy load, and defining an independent variable, which represents an influencing driver of the operation of the energy load. The computer-readable storage media also includes instructions for causing a processor to execute operations including receiving an input dataset at the load monitoring server, the input dataset including additional coincident values of the independent variable or variables and processing the additional coincident values of the independent variable or variables with the created models. The computer-readable storage media also includes instructions configured to cause a processor to execute operations including generating an output dataset with the load monitoring server from the created models, the output dataset including predicted dependent variable values coincident with values from the independent variable or variables from the input dataset.

According to aspects of the present disclosure, a computer-implemented method of monitoring and modeling an energy load in an electrical system is presented. The method includes, inter alia: determining one or more monitoring parameters; determining an energy conservation measure (ECM) evaluation period; creating an evaluation model of energy load over the ECM evaluation period based on the one or more monitoring parameters, the evaluation model including one or more driver variables and at least one additional driver variable representative of at least one energy conservation measure; determining a coefficient of the at least one additional driver variable within an equation representing the ECM evaluation model; and outputting to a user the coefficient of the at least one additional driver variable, the coefficient representing an average change in energy due to the at least one energy conservation measure associated with the at least one additional driver variable

In accordance with other aspects of the present disclosure, a non-transient computer-readable storage media for modeling an energy load in an electrical system is featured. The computer-readable storage media stores one or more computer-readable instructions configured to cause one or more computer processors to execute the following operations: establish one or more monitoring parameters; establish an energy conservation measure (ECM) evaluation; create an evaluation model of energy load over the ECM evaluation period based on the one or more monitoring parameters, the evaluation model including one or more driver variables and at least one additional driver variable representative of at least one energy conservation measure; determine a coefficient of the at least one additional driver variable within an equation representing the ECM evaluation model; and output an indication of the coefficient of the at least one additional driver variable, the coefficient representing an average change in energy due to the at least one energy conservation measure associated with the at least one additional driver variable.

According to other aspects of the present disclosure, a monitoring system is disclosed for monitoring and modeling an energy load in an electrical system. The monitoring system includes one or more intelligent electronic devices, each of which is configured to monitor a characteristic of the electrical system and output signals indicative thereof. The monitoring system also includes a computing device that is operatively connected to the one or more intelligent electronic devices. The computing device is configured to: establish one or more monitoring parameters; establish an energy conservation measure (ECM) evaluation period; create an evaluation model of energy load over the ECM evaluation period based on the one or more monitoring parameters, the evaluation model including one or more driver variables and at least one additional driver variable representative of at least one energy conservation measure; determine a coefficient of the at least one additional driver variable within an equation representing the ECM evaluation model; and display an indication of the coefficient of the at least one additional driver variable, the coefficient representing an average change in energy due to the at least one energy conservation measure associated with the at least one additional driver variable

The above summary is not intended to represent each embodiment or every aspect of the present disclosure. Rather, the foregoing summary merely provides an exemplification of some of the novel features included herein. The above features and advantages, and other features and advantages of the present disclosure, will be readily apparent from the following detailed description of the embodiments and best modes for carrying out the present invention when taken in connection with the accompanying drawings and appended claims.

### BRIEF DESCRIPTION OF THE DRAWINGS

FIG. 1 is a diagrammatic representation of an exemplary energy modeling and monitoring system in accordance with aspects of the present disclosure.

FIG. 2 is a graphical representation of the creation of an example of an energy model in accordance with aspects of the present disclosure, showing physical systems with observed physical properties as data stream inputs to a monitoring and modeling server.

FIG. 3 is a graphical representation of an exemplary model used to predict estimated electrical consumption based upon a variety of driver data in accordance with aspects of the present disclosure.

FIG. 4 is a graph which illustrates an example of a single driver model showing a nonlinear relationship approximated by a piecewise linear model.

FIG. 5A is a timeline portraying the implementation of an energy conservation measure (ECM) and corresponding introduction of an ECM driver variable into an evaluation model.

FIG. 5B is a timeline portraying the reference period of the evaluation model relative to the implementation of the ECM.

FIG. 6 is a flowchart for a method or algorithm that corresponds to instructions that can be stored on a non-transitory computer-readable medium and executed by one or more controllers in accord with at least some aspects of the present disclosure.

While the present disclosure is susceptible to various modifications and alternative forms, specific embodiments have been shown by way of example in the drawings and will be described in detail below. It should be understood, however, that the present disclosure is not intended to be limited to the particular forms disclosed. Rather, the present disclosure is to cover all modifications, equivalents, and alternatives falling within the spirit and scope of the invention as defined by the appended claims.

### DETAILED DESCRIPTION OF THE ILLUSTRATED EMBODIMENTS

Although aspects of the present disclosure are susceptible of embodiment in many different forms, there are shown in the drawings and will herein be described in detail representative embodiments of the present disclosure with the understanding that the present disclosure is to be considered as an exemplification of the various aspects and principles of this invention, and is not intended to limit the broad aspects of the present invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise.

Among the various aspects set out in this disclosure, a computer-implemented method of monitoring and modeling an energy load is presented which includes using a load monitoring server to define one or more influencing drivers that can affect operation of a system's energy load. The influencing driver, for instance, is akin to an independent variable (e.g., outdoor temperature) that affects system operation. The computer-implemented method also defines an operation of the energy load with the load monitoring server. The operation of the energy load may be a dependent variable, such as kilowatthours (kWh) in HVAC systems and lighting systems, for example. The method can then determine the effect that outdoor temperature has on the number of kilowatthours used in the HVAC system.

Once the variables are defined, a reference dataset can be received at a load monitoring server. This reference dataset may include coincident values of the dependent variable and the independent variables. In the HVAC system example set forth above, the reference dataset may include values of the outdoor temperature, the kilowatthours used, and the occupancy status of the building at a number of times during a day. The modeling and monitoring system and method can then create a model for the reference dataset with the load monitoring server. The model represents operation of the energy load of the system.

The acquisition of the reference data set and creation of the model may be accomplished by the same party, or the reference dataset may be acquired by one party and passed to another party responsible for creating the model. Similarly, additional parties may provide additional coincident data or variables to be used in the model. Similarly, additional parties may provide additional coincident data or variables. When the model is created and the variables are mapped, the accuracy of the model may be evaluated by entering a new set of input data. Input data may be received at the load monitoring server. The input data may include, for example, hypothetical measurements, estimated measurements, and the like. The input dataset may include additional coincident values of the independent variables (e.g., outdoor temperature, occupancy). The system may then process the additional coincident values of the independent variables with the created model and generate an output dataset with the load monitoring server from the created model.

The output dataset can include coincident values of the predicted dependent variable (e.g., kWh). The output dataset may further include coincident values of the independent variables from the input dataset. The input and output datasets may then be displayed to a user via a display device and/or stored via a computer-readable storage media, or otherwise examined further. The output dataset may then be used to make adjustments to the energy load system and take action to further dictate the operating behaviour of the energy load system.

Additionally, with the systems and methods disclosed herein, it is also possible to create models with more than one independent variable. If a simple linear model for a single independent variable has the form y=mx+b, for example, a linear model with multiple independent variables would have the form y=m₁x+m₂z+ . . . +b.

In a monitoring operation, the reference data may be used to show how the energy load is operating currently by taking real-time measurements of the dependent variable, and comparing the real-time measurement to a modeled dependent variable to evaluate any differences between the real and modeled readings.

An approach that can be employed to model a physical system is by the use of a linear regression model, which computes predicted quantities as linear combinations of scaled input quantities. The model can take measured and/or observable qualities of a physical system and predict the numerical characterization of some other quality of the system that is causally influenced by the observed qualities. As above, the observable qualities of the physical system that can be measured or observed are referred to as “independent variables.” The quality of the system that is thought to be causally influenced by the driver variables is called the “dependent variable.”

A linear change-point model, in general, is a mathematical formula that produces an estimate of a modeled variable from a driver data point, as a linear combination of drivers with the following general form:

y=β₁+β₂(X₁−β₄)⁻+β₃(X₁−β₅)⁺+β₆X₂+β₇X₃+ . . .
Influence of primary driver: β₂(X₁−β₄)⁻+β₃(X₁−β₅)⁺
Influence of second driver: β₆X₂
Influence of third driver: β₇X₃
β₁=Y Intercept,
X₁=Primary driver,
β₂=Left slope for the primary driver,
β₃=Right slope for the primary driver,
β₄=Left change point X value,
β₅=Right change point X value,
β₆=Slope of the 2^{nd} driver variable,
X₂=Secondary driver variable
β₇=Slope of the 3^{rd} driver variable,
X₃=Tertiary driver variable
   Note: the ( )+ and ( )− indicate that the values of the parenthetic term shall be set to zero when they are negative and positive respectively.

Modeling and monitoring an energy load in accordance with the present disclosure may be conducted empirically, for example, by looking at a reference dataset that captures both the driver and modeled variables for some time period (i.e., a “reference period”), and by then inferring the relationship that best estimates the modeled variable from the driver variables in that dataset.

Linear regression models may provide acceptable estimates for systems that respond in a linear way to their surroundings. But for systems that exhibit nonlinearity in the relationships between the driver data and the modeled variable, a single-system model often cannot be constructed that works well for different modes of system operation.

Unless otherwise noted, or as may be evident from the context of their usage, any terms, abbreviations, acronyms or scientific symbols and notations used herein are to be given their ordinary meaning in the technical discipline to which the invention most nearly pertains. The following terms, abbreviations, and acronyms, presented herein as non-limiting examples, may also used in the description contained herein. A modeled variable is a physical quantity that can be measured or observed and characterized numerically, and is believed to be causally influenced by one or more driver variables. A driver variable includes any physical quantity that can be measured or observed and characterized numerically. In some embodiments, the driver variables are limited to those elements, features, and/or factors that influence energy consumption. Examples of driver variables include, but are not limited to, indoor and outdoor temperature, humidity, barometric pressure, cloud cover, length of day, building occupancy, product colour, product weight, production activity, man-hours worked, and the like. Driver data is a sequence of time-stamped data values representing measurements or observations of a single driver variable. A driver data point is a set of values, one for each driver variable in a model, all of which are valid at the same point in time. Simultaneous values of temperature, pressure, wind speed and building occupancy could form a driver data point for a model which depended on those variables, for example.

A model is a mathematical formula that produces an estimate of the modeled variable from a driver data point. A reference dataset is a set of driver data and data for the modeled, dependent variable for some time period or periods—i.e., the reference period, which is considered to exemplify “typical” behaviour of the system to be modeled. The reference dataset is analyzed to determine the functional form of the model using linear regression, as one technique. A reference period is the time period or periods covered by the reference dataset.

An energy conservation measure (ECM) is a course of action (e.g., an equipment change, a usage change, etc.) taken to reduce energy consumption in a physical system, such as a building, a machine, a process, etc. An ECM Implementation date is the date on which an ECM took effect. As such, an ECM is expected to have a recognizable date on which it was implemented. The foregoing definitions are provided purely for explanation and clarity, and should not be construed as limiting.

According to some embodiments of the present disclosure, the system monitors the characteristic(s) of a physical system with an external instrument, such as an intelligent electronic device (IED), to produce monitored characteristic values that are buffered in the IED. The IED is communicatively coupled to a monitoring server via a communications network. The monitored characteristic values are indicative of the characteristic of the physical system. The server is used to model and monitor the performance and characteristics of the physical system as described above

The load monitoring server defines an independent variable, representing an influencing driver that affects operation of a system's energy load. The influencing driver is a driver of system behavior and is akin to an independent variable that affects system operation. In accordance with the present disclosure, the influencing driver may be outdoor temperature, which affects system operation of an HVAC system. A computer-implemented method of modeling and monitoring an energy load includes defining an operation of the energy load with the load monitoring server. As outlined above, the operation of the energy load may be a dependent variable, such as “kilowatthours” in the HVAC system example. The monitoring and modeling system may then be used to determine the effect that outdoor temperature has on the number of kilowatthours used in the HVAC system.

Once the variables are defined, the computer-implemented method for modeling and monitoring an energy load can receive a reference dataset at the load monitoring server. The reference dataset includes coincident values of the dependent variable and independent variable. In the HVAC system example, the reference dataset includes values of the outdoor temperature and the kilowatthours used. The modeling and monitoring system and method then creates a model representing operation of the energy load of the system. The acquisition of the reference data set and creation of the model may be accomplished by the same party, or the reference dataset may be acquired by one party and passed to another party responsible for creating the model. Similarly, additional parties may provide additional coincident data or variables to be used in the model.

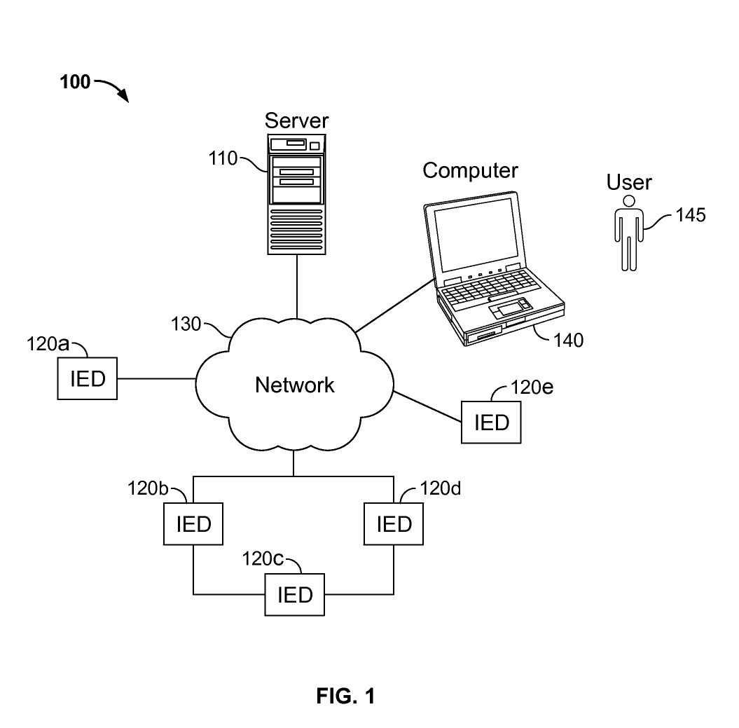

Referring to FIG. 1, an example of an energy monitoring system 100 is generally shown. The energy monitoring system 100 is represented herein by, but is certainly not limited to, a load monitoring server 110, a plurality of intelligent electronic devices 120a-e (hereinafter “IED”), a communications network 130, and a computer 140. The IEDs 120a-e are communicatively coupled through the communications network 130 to the load monitoring server 110 and the computer 140. Communications network 130 may be a wired or a wireless network, or a combination of wired and wireless technology. As used herein, an IED refers to any system element or apparatus with the ability to sample, collect, and/or measure one or more operational characteristics and/or parameters of an energy system. The energy system being monitored by the energy monitoring system 100 can be any of the five utilities designated by the acronym WAGES, or water, air, gas, electricity, or steam. The aspects of the present disclosure are not per se limited to these utilities, and could be any other physical system, such as a production facility, a production line, an HVAC system, other industrial facilities, commercial buildings, etc. The energy monitoring system 100 may also monitor other energy consuming systems related to the WAGES utilities, the other industrial facilities, and the like. In the electrical utility context, the IEDs may be based on a PowerLogic® CM4000T Circuit Monitor, a PowerLogic® Series 3000/4000 Circuit Monitor, a PowerLogic® ION7550/7650 Power and Energy Meter available from Schneider Electric or any other suitable monitoring device (e.g., circuit monitor), circuit breaker, relay, metering device, or power meter, or the like. The IED may be a microprocessor-based controller that is operable to receive data from sensors (e.g., optical sensors, thermal sensors, acoustic sensors, capacitive sensors, etc.), monitoring devices, power equipment, and/or other sources of information, and, in some embodiments, is also operable to issue control commands.

The energy monitoring system 100 can be configured to monitor one or more of a plurality of characteristics and/or parameters of any of the WAGES utilities or other physical systems. For an electrical utility, the energy monitoring system 100 may be configured to monitor electrical characteristics such as, for example, power, voltage, current, current distortion, voltage distortion, and/or energy. For other utilities, the energy monitoring system 100 can be configured to monitor volumetric flow rates, mass flow rates, volumetric flux, mass flux, and the like.

For simplicity and brevity, explanation of some of the aspects and features of the present disclosure will be made with reference to the energy monitoring system 100, which is configured to monitor energy (in watthours or kilowatthours, for example). Nevertheless, it is understood that all of the following embodiments and aspects can similarly be applied to monitoring any other electrical characteristic, or any other characteristic of any of the WAGES utilities or any other physical system, such as a production facility, a production line, a manufacturing facility, a factory, an HVAC system, other industrial facilities, and the like. Each of the IEDs 120a-e produce monitored characteristic values periodically at a monitoring interval, where the monitored characteristic values are indicative of the physical characteristic being monitored. Put another way, the IEDs 120a-e monitor power to produce a plurality of energy measurements indicative of the electrical power being consumed.

As outlined above, WAGES utilities and other physical systems may be modeled mathematically by taking one or more observable qualities of the physical system that can be measured or observed (the driver variables), and using these driver variables to predict the numerical characterization of some other quality of the system (the modeled variable) which is thought to be causally influenced by the drivers.

The systems and methods presented herein may include mathematically modeling physical systems using linear regression models, which compute a predicted quantity as a linear combination of scaled input quantities. Linear regression models can also include those models which compute a nonlinear transform of the predicted quantity as a linear combination of one or more scaled input quantities, any of which may also have been previously nonlinearly transformed. Common transformations used on input and modeled quantities include, but are not limited to logarithm, exponential, square, square root, and higher order polynomials. For example, independent variable values may be scaled such that the modeled relationship between the independent and dependent variables is linear. Additionally, the same scaling used to create the model may be applied to independent variable values when using the model to generate predicted dependent variable values.

Linear regression models may be created empirically, by looking at a dataset (the reference dataset) that captures both the driver and modeled variables for some time period (the reference period) and then inferring the relationship that best estimates the modeled variable from the driver variables in that dataset. Linear regression models can also include those which compute a nonlinear transform of the predicted quantity as a linear combination of one or more scaled input quantities, any of which may also have been previously nonlinearly transformed. For example, transformations used on input and modeled quantities include but are not limited to logarithm, exponential, square, square root, and higher order polynomials.

As an example shown in FIG. 1, power monitoring system 100 includes load monitoring server 110 and a group of attached sensors or other data entry means, including IEDs 120a-e. The system 100 of FIG. 1 may be used to predict the total electrical energy consumption in a particular industrial building in a day. So in the example of FIG. 1, the modeled variable is total daily energy consumption. To create the model, data must be supplied which capture the actual energy consumption during some period of observation in the past. Data must also be provided that characterize the physical influences on the building's energy consumption during the same time. These data are called driver data. Data of both kinds are provided via sensors or other data entry means, such as IEDs 120a-e.

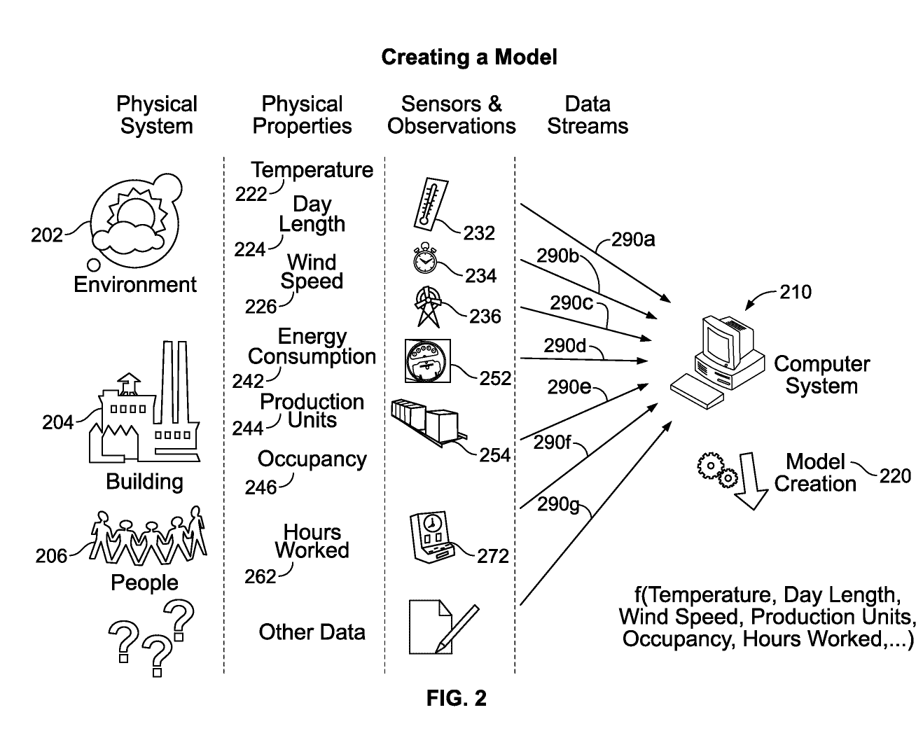

FIG. 2 expands the example of FIG. 1 to show that any physical system, including environment 202, building 204, and people 206 systems, possesses physical properties, such as temperature 222, day length 224, wind speed 226, energy consumption 242, production units 244, occupancy 246, hours worked 262, and other data, that may be observed and measured using sensors and other observational tools 232, 234, 236, 252, 254, 272. Streams of time-stamped data 290a-g indicate the outdoor weather temperature 222, length of day 224, wind speed 226, building occupancy 246, hours worked 262 by people inside the building, and a measure of business activity (such as the production units 244 of widgets manufactured, for example). The computer system server 210 can then analyze the time-stamped data 290a-g (reference data) for a reference time period to determine an optimal formula to model the relationship between the driver variables 222, 224, 226, 244, 246, 262 and the modeled variable (daily energy consumption 242, for example). Once this model 220 has been created, a prediction for energy consumption on any day can be made by supplying values for the driver variables for that day. That is, energy consumption 242 is a function of the driver variables 222, 224, 226, 244, 246, 262.

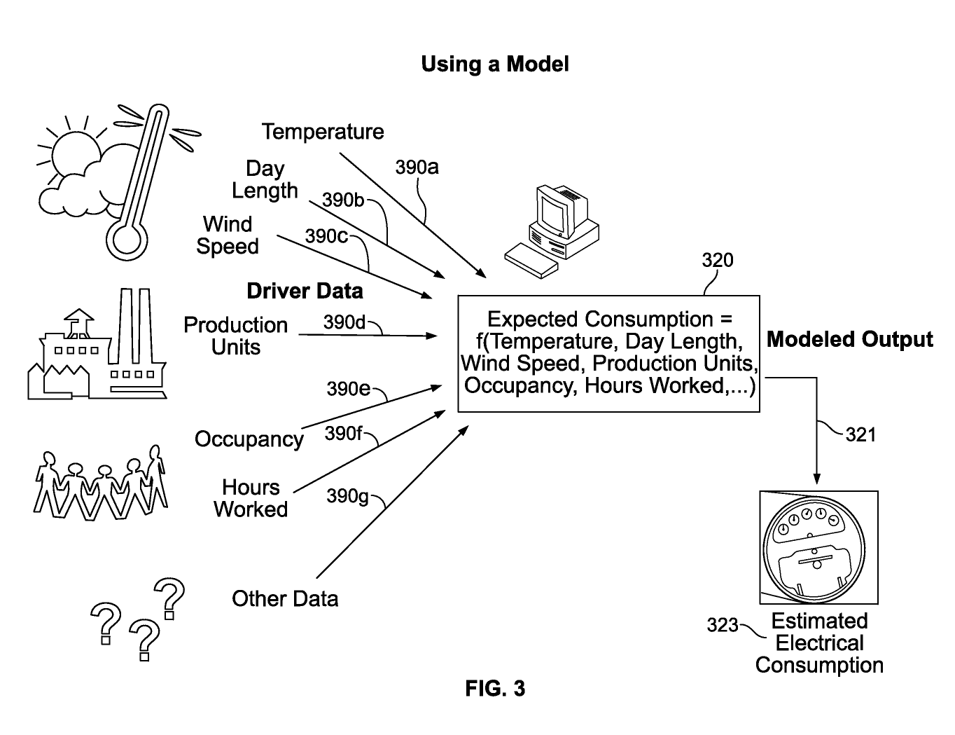

As shown in FIG. 3, the model 320 is then used by supplying driver variable data 390a-g for other time periods to generate a modeled output 321 that is an estimate 323 of what the modeled variable (electrical consumption) should be if the system 100 were still behaving as it did during the reference period.

The reference period may be any period or duration of time where the independent variables and the dependent variables are sampled. The monitoring interval may be any period or duration of time between producing the monitored characteristic values. For example, the monitoring interval can be one week, one day, one hour, one minute, one second, one tenth of a second, etc. For a monitoring interval of one second, the IEDs 120a-e in FIG. 1 produce a monitored characteristic value (e.g., derived from a power measurement) every second. An IED monitoring power every second may produce a periodic sequence of monitored characteristic values as follows: [99.7 kilowatthours, 99.8 kilowatthours, 100.2 kilowatthours, 100.1 kilowatthours, 125 kilowatthours]. Each of these power measurements corresponds to a monitored characteristic value produced periodically at consecutive one second intervals.

A non-limiting example of how the IEDs 120a-e can be used in practice provides that each of the IEDs 120a-e is a power monitor that monitors different aspects of an electrical utility in a building. The first IED 120a monitors an incoming electrical service to the entire building. The second, third, and fourth IEDs 120b-d monitor different circuits of a common voltage bus within the building. The fifth IED 120e monitors a critical electrical circuit for servers in a server room within the building. Each of the IEDs 120a-e monitors power draw and produces power measurements, that is, monitored characteristic values, periodically at the monitoring interval.

According to some embodiments, the monitored power values (characteristic values) and/or any associated information stored in the memory of the first IED 120a are transmitted over the network 130 to the load monitoring server 110 for storage and/or processing. According to some embodiments, the monitored characteristic values and/or associated information stored in the memory of the IEDs 120a-e are transmitted over the network 130 at predetermined intervals. For example, the monitored characteristic values and associated information can be transmitted every hour, every twelve hours, every day, every week, or every month. Other transmission schedules with more or less frequency are contemplated depending on the amount of memory in the IEDs 120a-e and the duration of the first logging interval.

A user 145 of the computer 140 (such as a workstation, personal computer, laptop computer, handheld, etc.) can view the monitored power values on a display. The user 145 may also view any associated information stored on the server 110. Optionally, the user 145 can connect a workstation computer 140 through the network 130 directly to one or more of the IEDs 120a-e to view and/or download the monitored characteristic values and/or associated information stored on the IEDs 120a-e on a video display.

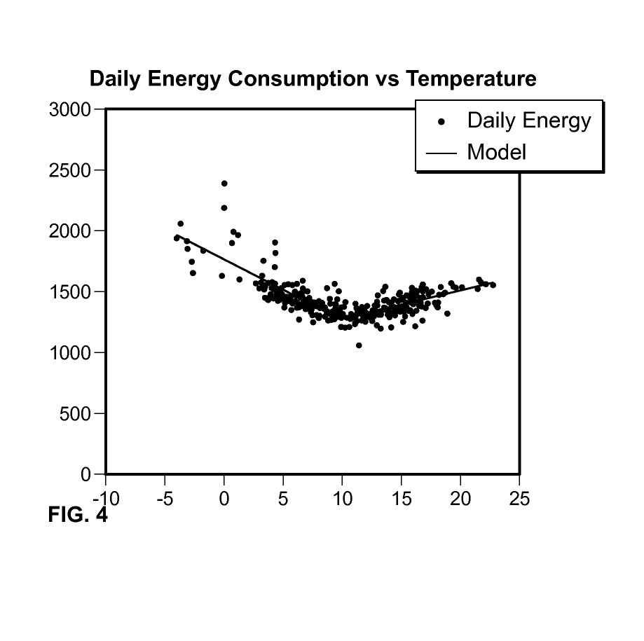

While conventional linear regression models may be acceptable for systems that respond in a linear way to their surroundings, for systems that exhibit nonlinearity in the relationships between the driver data and the modeled variable, piecewise linear models provide a simplified approach to approximating nonlinear models. FIG. 4 illustrates an example of a single driver model for energy consumption in a building as a function of average daily outdoor temperature showing a nonlinear relationship being approximated by a piecewise linear model.

Some physical systems may have regimes of linear or piecewise linear behaviour, each of which can be modeled well, but for which no single model will work for all of the regimes of applicability. One example of such a physical system is the energy consumption of a building whose heating and air conditioning system is under the control of an automated building management system (BMS). Building management systems may be “modal” in the sense that they have two or more operating modes corresponding to anticipated activity in the building. For example, the BMS may have “occupied” and “unoccupied” air conditioning and heating programs, each of which uses a different algorithm or process to control building air handling equipment. While energy consumption could be modeled well using a linear or piecewise linear model driven by outdoor temperature, occupancy, and business activity for each mode separately, no single model could be constructed that works for both occupied and unoccupied modes.

If each mode can separately be described accurately using a linear model, two models may be created, and a user can switch between the two models as needed. In this situation, during model creation, background data is divided into batches according to the time periods in which the physical system is presumed to be in each of the modes, and a model is constructed for each. A user may partition all system data into weekday and weekend times, and then construct two linear regression models, one for the weekday data and one for the weekend data. When using the models to make estimates of energy consumption, the weekday model would be used to predict weekday consumption, and the weekend model would be used to predict weekend consumption.

In this example, the division of data into groups based upon the time of the data recording would act as a “best guess” proxy for the operating mode of the system being modeled. As long as the operating modes of the building management system changed on the same time boundaries as the weekend/weekday choices that differentiate the model, the intent of having one model per mode would be satisfied.

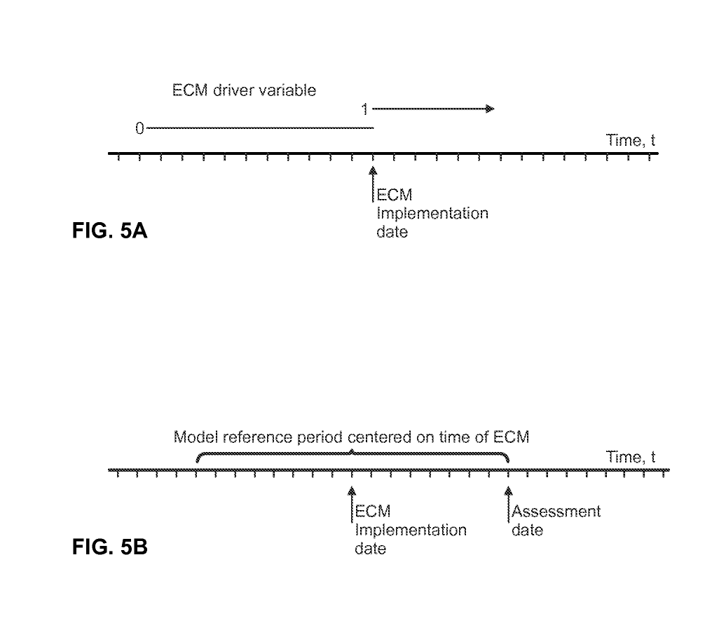

FIGS. 5A and 5B are timelines portraying the implementation of an energy conservation measure (ECM). As explained above, an ECM is a measure that is intended to reduce energy consumption. By way of non-limiting example, an ECM may be a retrofit of energy-efficient light bulbs or an energy-efficient HVAC unit in an office building. FIG. 5A illustrates the introduction of an ECM driver variable into an evaluation model as a result of the implementation of the ECM. For example, when a change in equipment or practices, i.e., an ECM, has been implemented that is expected to provide a reduction in energy consumption, an ECM evaluation model can be established with an ECM evaluation period that ends on the ECM assessment date and encompasses the ECM implementation date. This ECM evaluation period can include a length of time sufficient to capture all normal operating conditions of the energy system before the ECM implementation date, as well as a length of time sufficient to capture the impact of the ECM after the ECM implementation date. As a non-limiting example, consider an ECM linked to building occupancy designed to reduce the energy required to heat and cool a building. The ECM evaluation period should include a length of time spanning both heating and cooling seasons, before the ECM implementation date, in order to capture the influence of an outdoor temperature influencing driver on building energy consumption. In the same fashion, the ECM evaluation period can also include sufficient time after the ECM implementation date to capture the impact of the implemented ECM linked to building occupancy. The ECM evaluation model may take on the form of a single-parameter or a multi-parameter (e.g., 2-, 3-, . . . n-parameter) change-point model. Various other well-known mathematical modeling approaches, including alternative linear regression techniques and other control theories, can also be employed within the scope of this disclosure.

In addition to the driver variables discussed above, the ECM evaluation model also includes an additional driver variable (the “ECM driver”), typically in the nature of a dummy coded variable, that encodes the activation of the ECM, as developed in further detail below. In one embodiment, the value of the ECM driver is zero for all time prior to the ECM implementation date, whereas the value of the ECM driver is 1 from the ECM implementation time forward. In another embodiment, the value of the ECM driver alternates between “0” and “1” to capture when the ECM is inactive and when it is active, respectively. Normally, the ECM driver has the same sampling period as the model output. For instance, if the model predicts daily energy consumption, the ECM driver should have one entry per day, if the model predicts hourly energy consumption, the ECM driver should have one entry per hour, and so on.

If there are a total of n drivers in the original model, X₁ through Xₙ, the ECM driver will appear in the change-point model formula as Xₙ₊₁. The coefficient for this driver, which can be computed by regression analysis, is denoted βₙ₊₅ and its uncertainty is denoted Δβₙ₊₅ producing a final equation of the form:

y=β₁+β₂(X₁−β₄)⁻+β₃(X₁−β₅)⁺+β₆X₂+β₇X₃+ . . . +βₙ₊₅Xₙ₊₁

FIG. 5B, in turn, shows a representative reference period of the evaluation model (also referred to herein as “ECM evaluation period”) relative to the implementation of the ECM. In the illustrated example, the reference period of the ECM evaluation model starts at a time preceding the ECM implementation date and extends to an assessment date (which may be the present or the start of a new ECM after the one being evaluated). As noted above, the ECM evaluation period should encompass a length of time sufficient to evaluate the effectiveness of the ECM being evaluated.

Once the ECM evaluation model has been computed as described above, the coefficient βₙ₊₅ associated with the ECM driver variable in the resulting model formula will equal the average change in energy attributable to the ECM over the time period from the ECM implementation date to the assessment date (FIG. 5B). The units of measure will be the same as the modeled variable, and the value will represent the average change in energy from the ECM over the time period of the model output. The sign of the coefficient indicates an increase or decrease in the average change in energy, with a negative sign indicating a decrease and a positive sign indicating an increase. In instances where a model makes daily predictions of energy, the ECM coefficient indicates the average daily change in energy; likewise, if the model predicts hourly energy consumption, the ECM coefficient indicates the average hourly change in energy. The uncertainty associated with the coefficient Δβn+5 will reflect the uncertainty in the estimate

Using the above notation, the various βi terms are parameters of the model, and are computed based on the reference data. Associated with each of these parameters is an estimate of its uncertainty that results from a statistical t-test of the null hypothesis that the parameter is zero, indicating that the corresponding driver is unrelated to the modeled variable. This uncertainty can be expressed as Δβi and is analogous to the measurement uncertainty in a physical measurement. For the parameter computed for the ECM driver, βₙ₊₅, the uncertainty Δβₙ₊₅ resulting from the regression analysis can be interpreted as the uncertainty in the estimate of the periodic change in energy.

The concept of single ECM driver per ECM evaluation model described above can be extended to include a plurality of ECM drivers within a single ECM evaluation model, with each ECM driver modeled as a separate variable with its own ECM coefficient term. Each ECM coefficient indicates the average change in energy due to its corresponding ECM, and each ECM driver is assigned the ECM implementation date of its associated ECM. The portion of the ECM evaluation period after the ECM implementation date needs to be at least as long as the union of all time periods required to correctly assess all ECMs. In one embodiment, a pair of mutually exclusive ECMs may be implemented during the ECM evaluation reference period of the ECM evaluation model, with each associated ECM driver variable having a value of “0” or “1” opposite that of the other driver variable. This approach may be employed to evaluate two different ECMs within the ECM evaluation period in order to determine which offers the greatest potential for energy savings. As an example, consider two different building cooling control strategies designed to reduce the energy required to cool a building. A building automation system may be programmed to alternate the control strategy used from week to week, and a separate ECM driver would be configured for each strategy. When the first ECM control strategy is active, the value of its associated ECM driver variable would be “1”, and the value of the ECM driver variable associated with the second ECM control strategy would be “0”. In the same fashion, when the second ECM control strategy is active, the value of its associated ECM driver variable would be “1”, and the value of the ECM driver variable associated with the first ECM control strategy would be “0”.

As described above, energy loads sometimes operate in a “modal” fashion, and more than one energy model may be used to capture the operation of a load (with one model for each mode). When one or more models are used to capture the modal operation of an energy load, each model incorporates the one or more ECM driver variables indicating when their associated energy conservation measures are implemented. As an example, consider an HVAC load controlled by a BMS within a building. The BMS may have separate control strategies for operating the building when it is occupied and unoccupied, and two separate energy models may be developed: one to capture the HVAC energy consumption vs. outdoor temperature when the building is occupied, and one to capture the HVAC energy consumption vs. outdoor temperature when the building is unoccupied. In one embodiment, one ECM is implemented during both occupied and unoccupied times, and state of this ECM is represented by a single ECM driver variable incorporated within each model. A separate coefficient is associated with the ECM driver within the equation describing each ECM evaluation model, and each coefficient represents the average change in energy within each measurement interval due to the ECM.

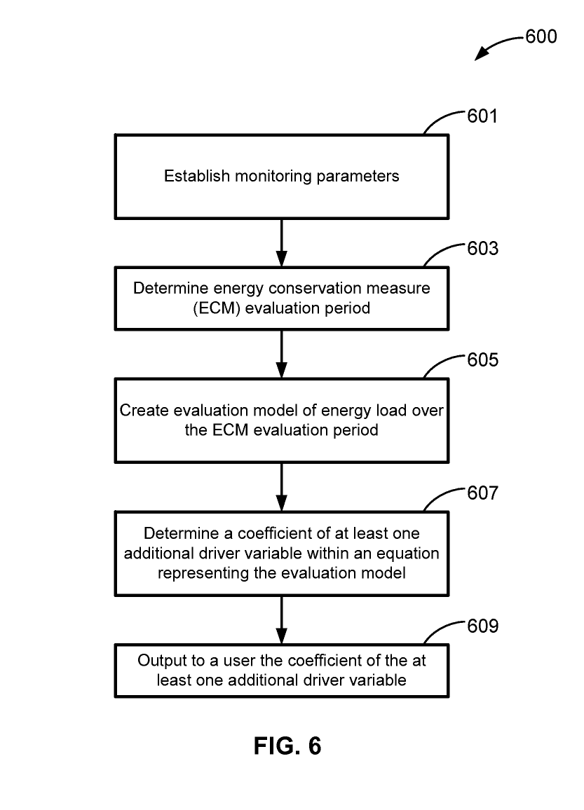

The flowchart of FIG. 6 diagrammatically illustrates an improved method of modeling and monitoring an energy load in a physical system, designated generally as 600, in accordance with aspects of the present disclosure. In some specific embodiments, the flow chart of FIG. 6 can be considered representative of an algorithm for modeling and monitoring an energy load. FIG. 6 can additionally (or alternatively) represent an algorithm that corresponds to at least some instructions that can be stored, for example, in a memory device, and executed, for example, by a controller or processor, to perform any or all of the above or below described steps associated with the disclosed concepts.

As indicated at block 601, the method 600 includes establishing one or more monitoring parameters. In some embodiments, the monitoring parameters are configured by a user, starting from system supplied default monitoring parameters that are preprogrammed into the software. Alternative implementations are certainly envisioned, including scenarios where one or more of the monitoring parameters are independently established by the system or the user. Other inputs, including ancillary parameters and variables, can be made during building of the ECM evaluation model, which can be based on common industry knowledge on energy modeling. The monitoring parameters established at block 601 may include, singly and in any combination, determining dependent and independent variables, and determining an ECM evaluation period for an ECM evaluation model, for example. Additional and alternative monitoring parameters can be established as part of block 601 without departing from the intended scope and spirit of the present disclosure.

Block 603, as indicated in FIG. 6, includes determining an energy conservation measure (ECM) evaluation period. The ECM evaluation period typically ends on the ECM assessment date and encompasses the ECM implementation date. As noted above, this evaluation period should include a (first) length of time sufficient to capture the normal operating conditions of the energy system before the ECM implementation date, as well as a (second) length of time sufficient to capture the impact of the ECM after the ECM implementation date.

At block 605, an ECM evaluation model of energy load is created. The ECM evaluation model, as explained above, is created over the ECM evaluation period and is based, at least in part, on the monitoring parameter(s) established at block 601. The ECM evaluation model characterizes the consumption of energy, for example, in a manufacturing process or part of a manufacturing process, in a system or portion of a system, by a building or area of a building, etc., based on one or more driver variables like weather, occupancy, production activity, etc. As indicated above, the ECM evaluation model can be created using a linear regression method, which may be in the nature of a piece-wise multi-parameter linear regression method. A change-point model is typically used; however, the type of model often depends, for example, on the system characteristic being modeled. When modeling building energy consumption as a function of outdoor temperature, for example, the relationship observed is typically nonlinear in a way that's captured well by a change-point model. Determining whether to use a 2-parameter, 3-parameter, 4-parameter, etc. model is usually selected by a model-building tool according to well-known industry practice. Typically, the model-building tool will create a model of each type and pick the one that provides the best fit for a particular dataset.

In some embodiments, block 605 also includes defining, e.g., via the load monitoring server 110 of FIG. 1, the dependent variable that is representative of the operation of an energy load, and the one or more independent variables which are representative of one or more influencing drivers of the operation of an energy load. The operation of the energy load may be a dependent variable, such as “kilowatthours” in an HVAC system. The influencing drivers are akin to independent variables that affect system operation of the HVAC system, in the example above. In one example, the influencing driver may be outdoor temperature or any other logically relevant driver variables, such as those identified above or below. The outdoor temperature affects system operation of the HVAC system in the building example. The monitoring and modeling system may then be used to determine the specific effect that outdoor temperature has on the number of kilowatthours used in the HVAC system.

Once the variables are defined, the method may further include receiving a reference dataset, for example, at the load monitoring server 110 of FIG. 1. In some implementations, the reference dataset includes coincident values of the operation of the energy load (dependent variable) and the influencing driver (independent variable). In the HVAC system example, the reference dataset includes values of the kilowatthours used and the outdoor temperature.

Block 607 then includes determining a coefficient of at least one additional driver variable within an equation representing the evaluation model. The coefficient, if computed by regression analysis, is denoted βₙ₊₅ and its uncertainty is denoted Δβₙ₊₅. As indicated hereinabove, the coefficient βn+5 associated with the ECM driver variable in the resulting model formula will equal the average change in energy attributable to the ECM over the time period from the ECM implementation date to the assessment date (see, e.g., FIG. 5B). At block 609, the method 600 outputs the coefficient of the additional driver variable(s) to a user, e.g., via a display device and/or stores the coefficient via a computer-readable storage media.

Any of the methods described herein can include machine readable instructions for execution by: (a) a processor, (b) a controller, and/or (c) any other suitable processing device. It will be readily understood that the IEDs 120a-e, the server 110, and/or the computer 140 can include such a suitable processing device. Any algorithm, software, or method disclosed herein can be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine readable instructions represented in any flowchart depicted herein may be implemented manually. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

While particular aspects, embodiments, and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A computer-implemented method of monitoring and modeling an energy load in an electrical system, the method comprising:
determining one or more monitoring parameters;
determining an energy conservation measure (ECM) evaluation period;
creating an evaluation model of energy load over the ECM evaluation period based on the one or more monitoring parameters, the evaluation model including one or more driver variables and at least one additional driver variable representative of at least one energy conservation measure;
determining a coefficient of the at least one additional driver variable within an equation representing the ECM evaluation model; and
outputting to a user the coefficient of the at least one additional driver variable, the coefficient representing an average change in energy due to the at least one energy conservation measure associated with the at least one additional driver variable.

2. The method of claim 1, wherein the ECM evaluation period terminates on an ECM assessment date.

3. The method of claim 1, further comprising receiving a reference dataset including coincident values of the operation of the energy load and an influencing driver.

4. The method of claim 1, wherein the at least one additional driver variable is a dummy coded variable.

5. The method of claim 4, wherein the value of the at least one additional driver variable is zero (0) for a time period prior to an ECM implementation date and one (1) for a time period after the ECM implementation time.

6. The method of claim 4, wherein the at least one ECM alternates between active and inactive during the ECM evaluation period, and the at least one additional driver variable is zero (0) when the ECM is inactive and one (1) when the ECM is active.

7. The method of claim 7, wherein the at least one ECM is comprised of two mutually exclusive ECMs, each ECM having its own associated additional driver variable, with one of the associated additional driver variables having a value of zero (0) or one (1) opposite that of the other associated additional driver variable

8. The method of claim 1, wherein the operation of the energy load is modal and represented by a separate energy model for each mode, each energy model incorporating the one or more additional driver variables, each energy model equation including separate coefficients for the one or more driver variables

9. The method of claim 1, wherein the ECM evaluation model is created using a linear regression method.

10. The method of claim 10, wherein the linear regression method is a piece-wise multi-parameter linear regression method.

11. The method of claim 1, wherein the ECM evaluation model is created using a change-point linear regression model.

12. The method of claim 1, further comprising determining an uncertainty for the coefficient of the at least one additional driver variable.

13. The method of claim 12, wherein the uncertainty results from a statistical t-test of the null hypothesis that the parameter is zero.

14. The method of claim 1, wherein a positive sign of the coefficient indicates an increase in the average change in energy and a negative sign of the coefficient indicates a decrease in the average change in energy.

15. The method of claim 1, wherein the evaluation model includes a plurality of driver variables.

16. The method of claim 15, wherein each of the driver variables is modeled as a separate variable with a respective coefficient term.

17. The method of claim 1, wherein the dependent variable of the ECM evaluation model is a measurement of an electrical utility service quantity including current, voltage, power, or energy, or any combination thereof.

18. The method of claim 1, wherein the one or more driver variables include outdoor temperature, barometric pressure, humidity, cloud cover characteristics, length of day, building occupancy, production units, or man-hours worked, or any combination thereof.

19. A non-transient computer-readable storage media for modeling an energy load in an electrical system, the computer-readable storage media comprising one or more computer-readable instructions configured to cause one or more computer processors to execute the operations comprising:
establish one or more monitoring parameters;
establish an energy conservation measure (ECM) evaluation period;
create an evaluation model of energy load over the ECM evaluation period based on the one or more monitoring parameters, the evaluation model including one or more driver variables and at least one additional driver variable representative of at least one energy conservation measure;
determine a coefficient of the at least one additional driver variable within an equation representing the ECM evaluation model; and
output an indication of the coefficient of the at least one additional driver variable, the coefficient representing an average change in energy due to the at least one energy conservation measure associated with the at least one additional driver variable.

20. A monitoring system for monitoring and modeling an energy load in an electrical system, the monitoring system comprising:
one or more intelligent electronic devices each configured to monitor a characteristic of the electrical system and output signals indicative thereof;
a computing device operatively connected to the one or more intelligent electronic devices, the computing device being configured to:
establish one or more monitoring parameters;
establish an energy conservation measure (ECM) evaluation period;
create an evaluation model of energy load over the ECM evaluation period based on the one or more monitoring parameters, the evaluation model including one or more driver variables and at least one additional driver variable representative of at least one energy conservation measure;
determine a coefficient of the at least one additional driver variable within an equation representing the ECM evaluation model; and
display an indication of the coefficient of the at least one additional driver variable, the coefficient representing an average change in energy due to the at least one energy conservation measure associated with the at least one additional driver variable.
